(19) United States
(12) Patent Application Publication
(10) Pub. No.: US 2018/0020304 A1
(43) Pub. Date: Jan. 18, 2018

(54) Loudspeaker

(71) Applicants: Shengrong Shi, Shenzhen (CN); Fuhu Zhang, Shenzhen (CN); Ronglin Linghu, Shenzhen (CN)

(72) Inventors: Shengrong Shi, Shenzhen (CN); Fuhu Zhang, Shenzhen (CN); Ronglin Linghu, Shenzhen (CN)

(73) Assignee: AAC Technologies Pte. Ltd., Singapore city (SG)

(21) Appl. No.: 15/416,862

(22) Filed: Jan. 26, 2017

(30) Foreign Application Priority Data
Jul. 18, 2016 (CN) 201620757736.8

(51) Int. Cl. H04R 29/00; H04R 9/02; H04R 7/18; H04R 9/06; H04R 7/12

(52) U.S. Cl. CPC H04R 29/003; H04R 9/06; H04R 7/127; H04R 7/18; H04R 9/025

(57) ABSTRACT

A loudspeaker is disclosed. The loudspeaker includes a frame; a vibration system accommodated in the frame, a voice coil for driving the voice diaphragm and a support installed at one end of the voice coil away from the voice diaphragm. The vibration system includes a voice diaphragm, and the support is connected to the frame for providing elastic support to the voice coil. The loudspeaker further includes a magnetic circuit system for driving the vibration system. The magnetic circuit system includes a yoke, a first magnet portion, and a second magnet portion. The second magnetic portion includes an auxiliary magnet and an auxiliary pole plate overlapped with the auxiliary magnet. A light source installed on the auxiliary pole plate and opposite to the support, and a photosensitive sensor arranged on the support and being within the irradiation scope of the light source are further provided.

### FIELD OF THE INVENTION

The present disclosure relates to the field of electroacoustic transducer, more particularly to a loudspeaker.

### DESCRIPTION OF RELATED ART

As a kind of sound generator used for the electric equipment including the mobile phones and tablets etc., the loudspeaker has been applied in the people's daily lives extensively.

In the relevant technologies, a loudspeaker comprises a vibration system and a magnetic circuit system driving the vibration system to vibrate. The vibration system comprises a vibrating diaphragm and a voice coil driving the vibrating diaphragm. During the vibration of the vibrating diaphragm, when an amplitude is too much, it is easy to drive the other parts in the vibrating system to collide with the fixed parts in the loudspeaker, which will make the sound signal distorted, and the loudspeaker can't guarantee its high quality auditory impression and sound quality sustainably, and it is difficult to guarantee the reliability yield of a product.

Thereof, it is necessary to disclose a loudspeaker thereof.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a loudspeaker with an exemplary embodiment of the present disclosure.

FIG. 2 is an exploded view of the loudspeaker in FIG. 1.

FIG. 3 is a cross-sectional view of the loudspeaker taken along line A-A in FIG. 1.

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of the present disclosure more apparent, the present disclosure is described in further detail together with the figures and the embodiment. It should be understood the specific embodiment described hereby are only to explain this disclosure, not intended to limit this disclosure.

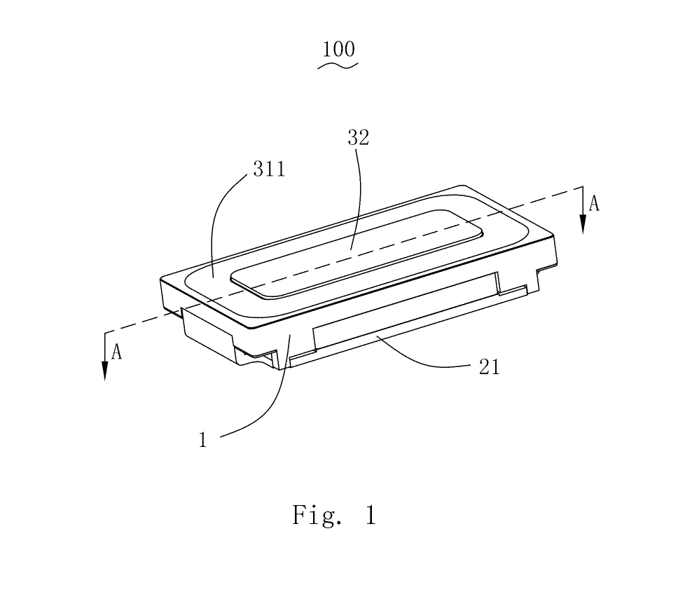

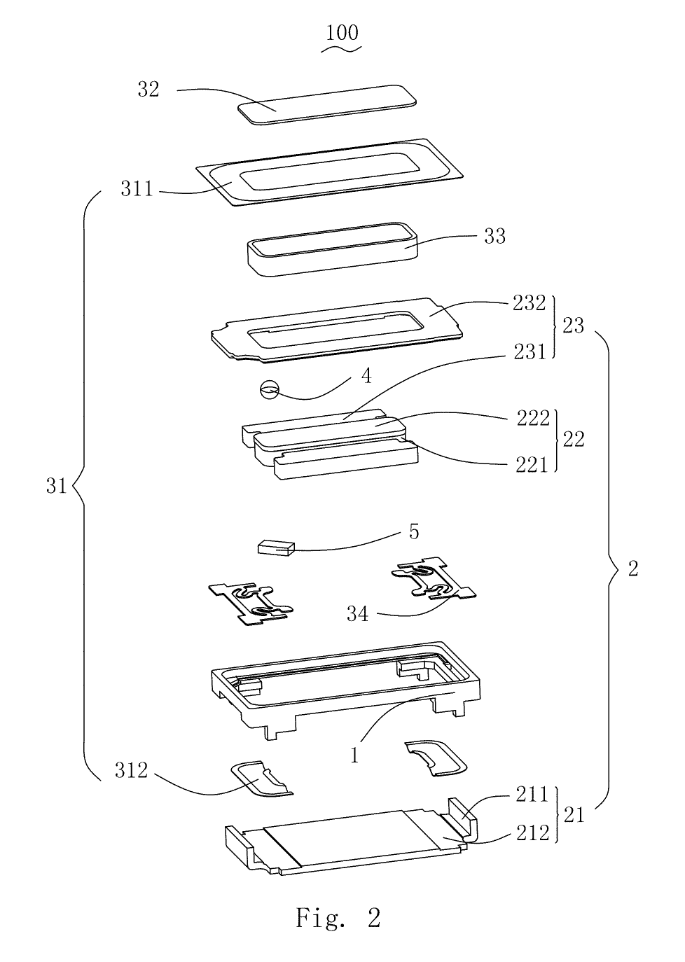

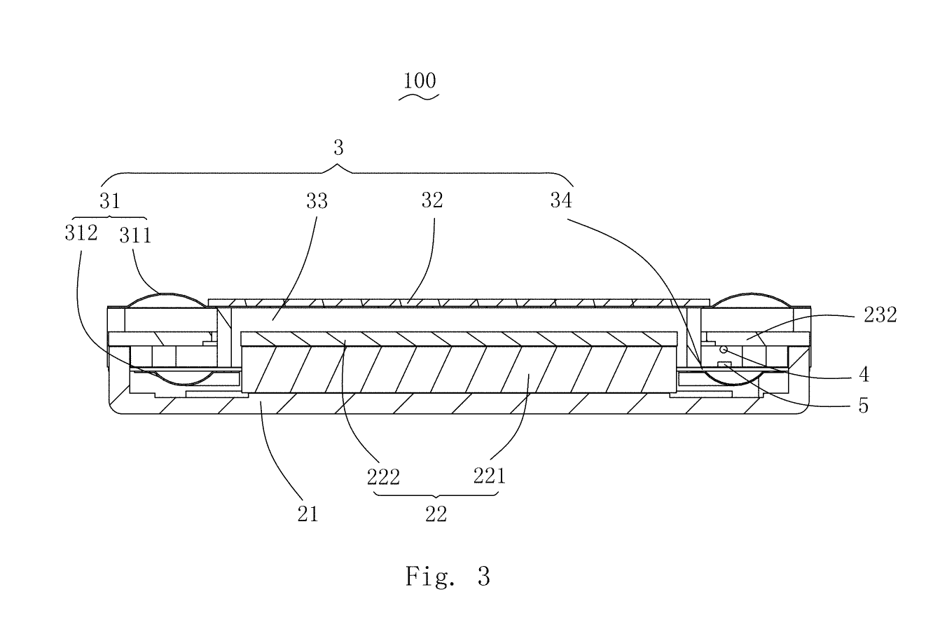

Referring to FIGS. 1-3, a loudspeaker 100 in accordance with an exemplary embodiment of the present disclosure comprises a frame 1, a magnetic circuit system 2, a vibrating system 3, a light source 4 and a photosensitive sensor 5.

The frame 1 has an accommodation space, and the magnetic circuit system 2, the vibrating system 3, the light source 4 and the photosensitive sensor 5 are accommodated in the accommodation space.

The magnetic circuit system 2 comprises a yoke 21 fixed to the frame 1, a first magnet portion 22 positioned by the yoke 21 and a second magnet portion 23 forming a magnetic gap with the first magnet portion 22.

The yoke 21 comprises a base plate 211 and a side plate 212 extending from both sides of the base plate 211. The side plate 212 is connected to the frame 1.

The first magnet portion 22 comprises a main magnet 221 and a main pole plate 222 attached to the main magnet 221.

The second magnet 23 comprises an auxiliary magnet 231 and an auxiliary pole plate 232 mounted on the auxiliary magnet 231. Two auxiliary magnets 231 are located at two sides of the main magnet 221 opposite to each other. The auxiliary pole plates 232 locate around the main pole plate 222 and keep a distance from the main pole plate 222.

The vibration system 3 comprises a voice diaphragm 31, a dome 32, a voice coil 33 driving the voice diaphragm to vibrate and a support 34 connected to the frame 1 for providing elastic support to the voice coil 33.

The voice diaphragm 31 comprises an upper voice diaphragm 311 and a lower voice diaphragm 312. The upper voice diaphragm 311 is connected to one end of the frame 1 away from the yoke 21, and the dome 32 is connected to the upper voice diaphragm 311. One end of the voice coil 33 away from the yoke is connected to the dome 32, and the other end is inserted into the magnetic gap.

The voice coil 33 comprises a pair of long axis sides and a pair of minor axis sides for enclosing the voice coil 33 by connecting their ends to their heads. The auxiliary magnet 231 is installed along the long axis side, and the support 34 is installed along the minor axis side. The auxiliary pole plate locates around the periphery of the first magnet portion 22.

The lower voice diaphragm 312 is attached on the surface of one side of the support 34 away from the voice coil 33, and the lower voice diaphragm 312 and the voice coil 33 are distributed at two sides of the support 314 opposite to each other, and the lower voice diaphragm 312 is distributed at two minor axis sides of the voice coil 33.

Both the light source 4 and the photosensitive sensor 5 are connected to an external circuit, and connected to and powered by their respective power sources. The light source 4 detects the amplitude of the voice diaphragm 31 for outputting a light signal, and the photosensitive sensor 5 receives the light signal from the light source 4 for sensing an illumination of the light source 4 and converts the light signal into an electric signal. The light source 4 is arranged on the pole plate 232. The photosensitive sensor 5 is arranged on the support 314 for making the photosensitive sensor 5 in the irradiation scope of the light source 4.

Optionally, the light source 4 and the photosensitive sensor 5 are disposed opposite to each other, in order to make the photosensitive sensor 5 receive a stronger light signal, and benefit improving the accuracy of the testing result.

The photosensitive sensor 5 is a kind of photodiode, phototransistor, photoresistor or photomultiplier for obtaining the amplitude of the voice diaphragm 31 by a current signal collected accurately.

When working, the light source 4 outputs the amplitude of the voice diaphragm 31, and the photosensitive sensor 5 receives a light signal from the light source 4, and converts an amplitude change of a voice diaphragm 31 into a change of an electric signal, and outputs the change data of the electric signal to an external circuit, and the external circuit obtains an amplitude signal of the voice diaphragm 31 by testing a current signal output by the photosensitive sensor 5, so as to adjust an input signal of the loudspeaker 100, and make its amplitude of the voice diaphragm 31 in the extreme scope where any collision doesn't occur constantly, in order to guarantee its auditory impression and sound quality of the loudspeaker sustainably.

Comparing with relevant technologies, by adding a light source 4 and a photosensitive sensor 5 connected to an external circuit, the photosensitive sensor 5 converts an amplitude change of a voice diaphragm 31 into a change of an electric signal, and outputs the change data of the electric signal to an external circuit, and the external circuit obtains an amplitude signal of the voice diaphragm by testing a current signal output by the photosensitive sensor 5, so as to adjust an input signal of the loudspeaker, and make its amplitude of the voice diaphragm 31 in the extreme scope where any collision doesn't occur constantly, in order to guarantee its 100 auditory impression and sound quality of the loudspeaker sustainably.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A loudspeaker comprising:
a frame;
a vibration system accommodated in the frame, the vibration system including a voice diaphragm, a voice coil for driving the voice diaphragm and a support installed at one end of the voice coil away from the voice diaphragm, the support being connected to the frame for providing elastic support to the voice coil;
a magnetic circuit system accommodated in the frame for driving the vibration system, the magnetic circuit system including a yoke fixed to the frame, a first magnet portion positioned by the yoke, and a second magnet portion forming a magnetic gap with the first magnet portion; the second magnetic portion including an auxiliary magnet and an auxiliary pole plate overlapped with the auxiliary magnet;
a light source installed on the auxiliary pole plate and opposite to the support; and
a photosensitive sensor arranged on the support and being within the irradiation scope of the light source.

2. The loudspeaker as described in claim 1, wherein the voice coil comprises a pair of long axis sides and a pair of minor axis sides, the auxiliary magnet is disposed along the direction of the long axis side, and the support is disposed along the direction of the minor axis side.

3. The loudspeaker as described in claim 1, wherein the light source and the photosensitive sensor are arranged opposite to each other.

4. The loudspeaker as described in claim 1, wherein the photosensitive sensor is a photodiode, a phototransistor, a photoresistor or a photomultiplier.

5. The loudspeaker as described in claim 1, wherein the voice diaphragm comprises an upper voice diaphragm connected to one end of the frame away from the yoke, a dome portion connected to the upper voice diaphragm and a lower voice diaphragm attached to the support, one end of the voice coil away from the support is connected to the dome portion, and the lower voice diaphragm and the voice coil are arranged at two opposed sides of the support.

6. The loudspeaker as described in claim 4, wherein the lower voice diaphragm is disposed at two minor axis sides of the voice coil.
